(19) United States
(12) Patent Application Publication
(10) Pub. No.: US 2014/0246348 A1
(43) Pub. Date: Sep. 4, 2014

(54) PLANT CONTAINER

(71) Applicant: Allan Mark Seddon, Edgworth (GB)

(72) Inventor: Allan Mark Seddon, Edgworth (GB)

(21) Appl. No.: 14/345,271

(22) PCT Filed: Aug. 6, 2012
(86) PCT No.: PCT/GB2012/000641

§ 371 Date: Mar. 17, 2014

(30) Foreign Application Priority Data
Aug. 9, 2011 (GB) 1113714.8

(51) Int. Cl. A01G 9/02

(52) U.S. Cl. CPC A01G 9/02
USPC 206/423

(57) ABSTRACT

A plant container which has one or more openings throughout its wall and has parts of that wall which can be manipulated to so that plants can be more easily inserted into said openings in the wall of the plant container.

### FIELD OF INVENTION

This invention relates to plant containers

### BACKGROUND

Baskets are used to contain plants (usually flowering plants) and these planted out baskets are hung by chains or fastened to walls or stands for ornamental reasons. With most baskets that are side-planted, the installation of the plants is a laborious job and in the process the plants are often damaged and stressed as their roots are often squeezed through small holes

### DESCRIPTION

Aspects and examples of the invention are set out in the claims. The invention provides a product in which plants, which are to grow through the sidewall of the container, can be installed very quickly without stressing or damaging the plants. This is achieved by having sections of the container that can be temporarily deformed or manipulated so as to produce a path or enlarged hole to facilitate the easy installation of the plant. After the plants are in position, the container is returned to its original shape.

### SUMMARY OF DRAWINGS

An embodiment of the invention will now be described, by way of example only, with reference to the accompanying drawings in which:

FIG. 1 illustrates a the first plant being installed into a container where the deformable sections extend to the rim

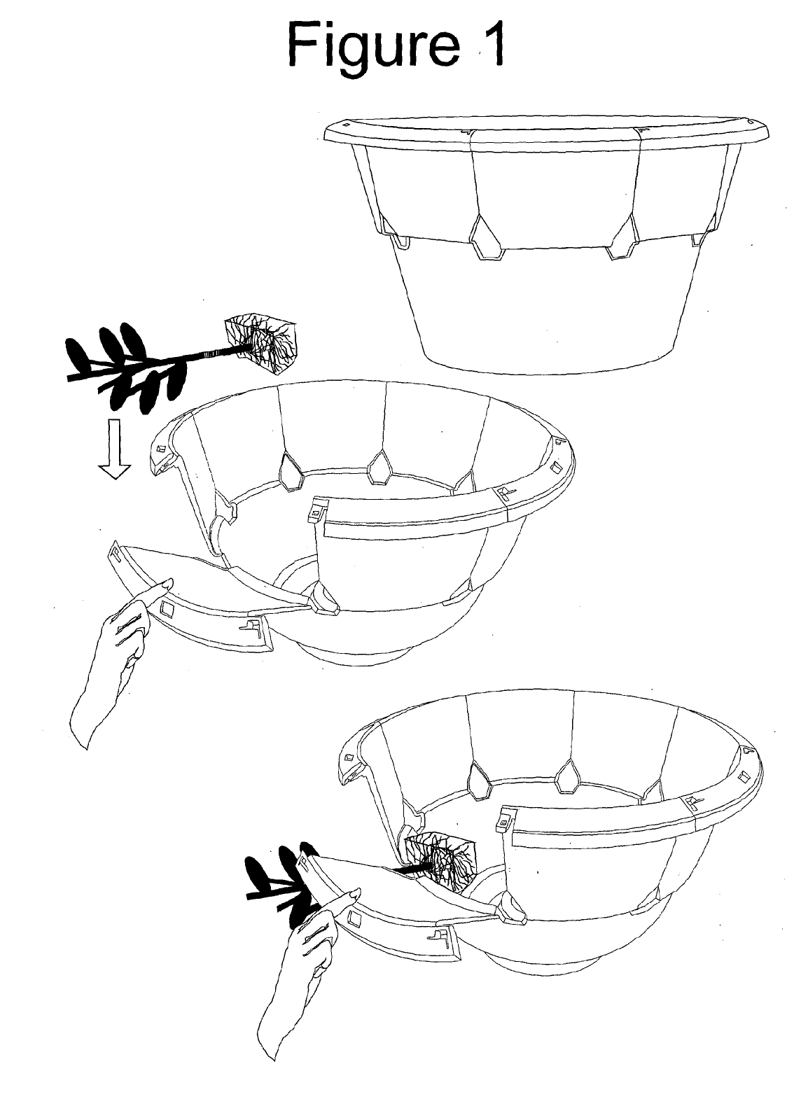

FIG. 2 illustrates the previously deformed section being returned to its original shape and further plants being added

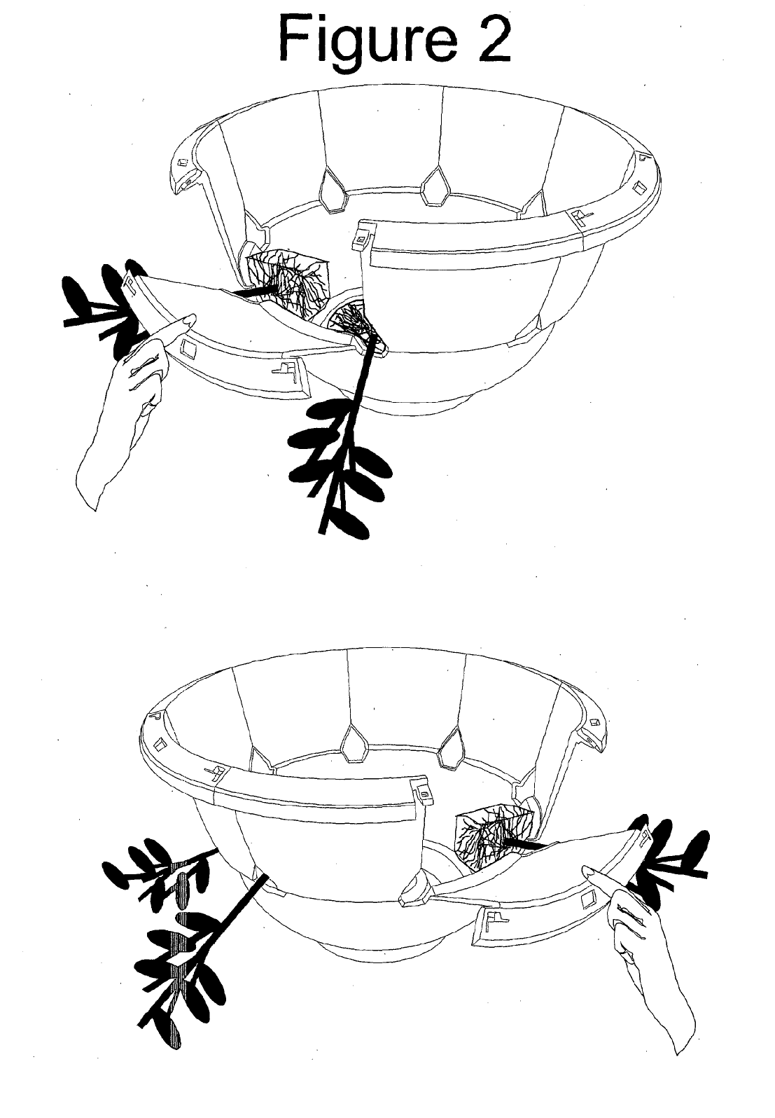

FIG. 3 illustrates the completion of the planting out of the container

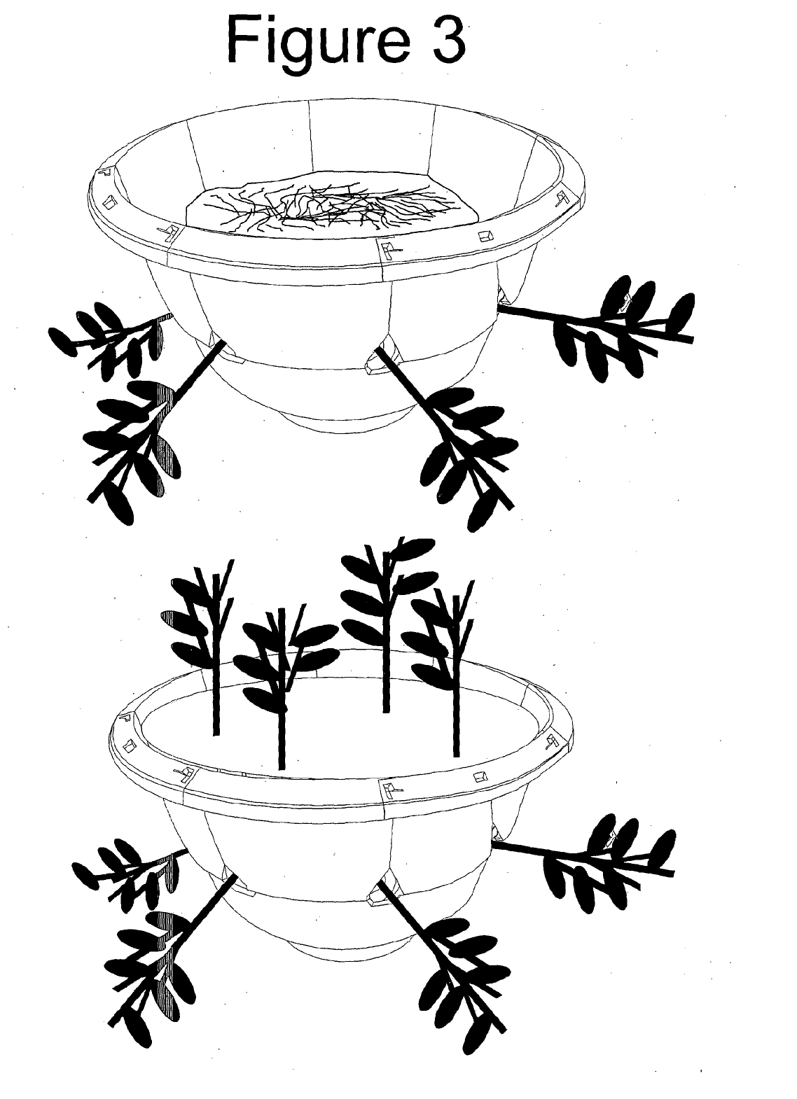

FIG. 4 illustrates the first plant being installed into a container where the deformable section does not reach the rim

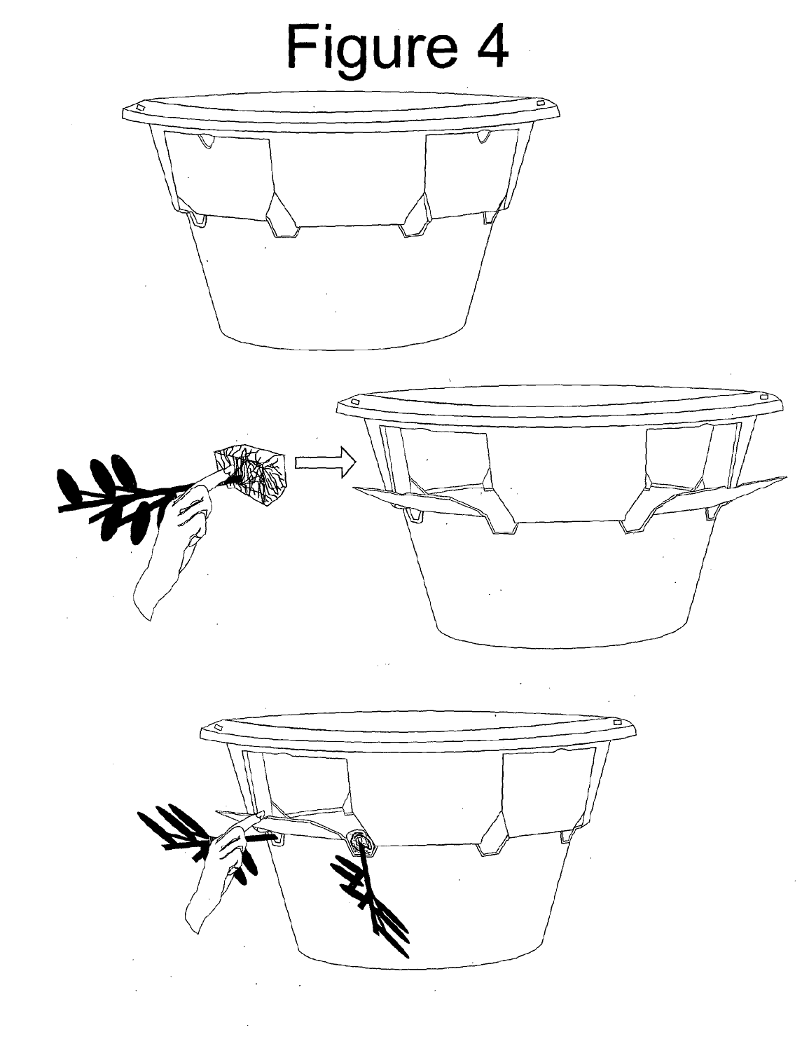

FIG. 5 illustrates the completion of the planting out of the container

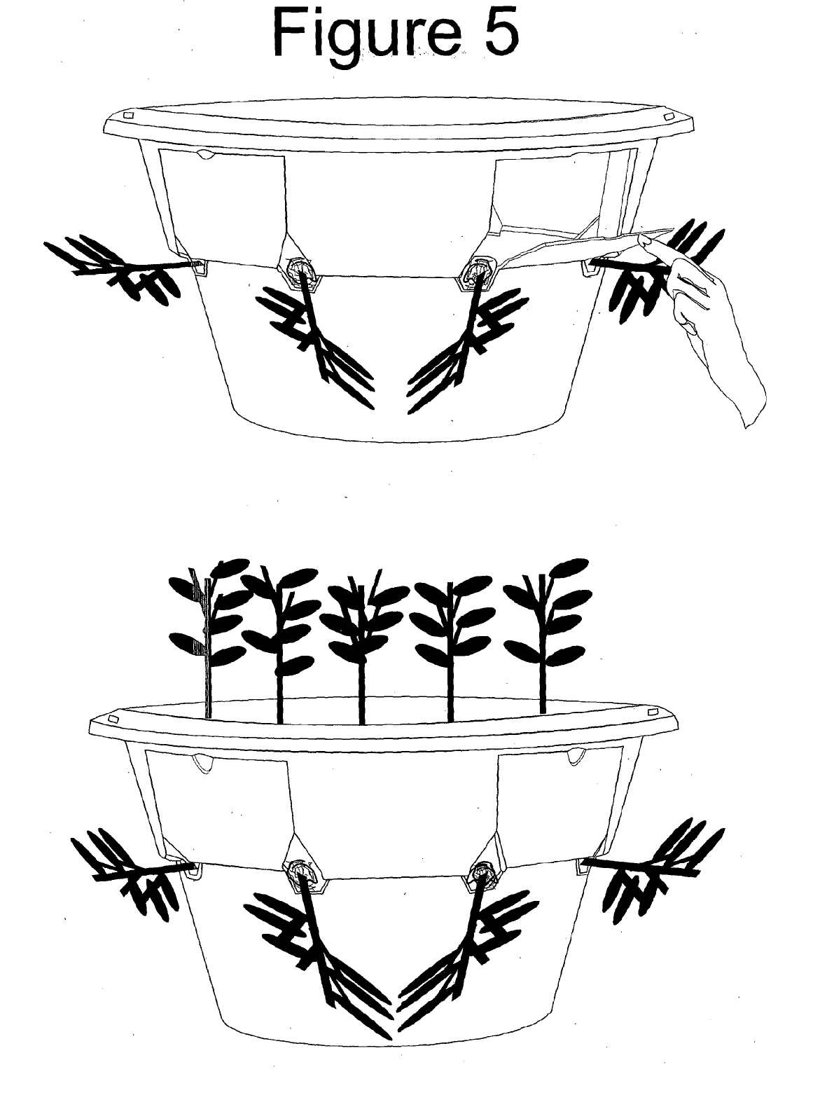

1. A plant container which has one or more openings throughout its wall; said openings being affected via manipulation of the wall of the plant container so that plants can be more easily inserted into said plant container.

2. A plant container as in claim 1, wherein the manipulation of the wall is such that the closed perimeter is broken to create an open perimeter.

3. A plant container as in claim 1, wherein the manipulation of the wall is such that the openings throughout the wall are increased in size or changed in shape.

4. A plant container as in claim 2, wherein the closed perimeter is broken via the deformation of the wall.

5. A plant container as in claim 2, wherein the closed perimeter is broken via relative motion of a section of said wall relative to another section of said wall.

6. A plant container as in claim 3, wherein the openings are increased in size or changed in shape via the deformation of the wall.

7. A plant container as in claim 3, wherein the openings are increased in size or changed in shape via relative motion of a section of said wall relative to another section of said wall.

8. A plant container as in claim 5, wherein the relative motion involves the rotation of one or more wall sections around hinges.

9. A plant container as in claim 5, wherein the relative motion involves the sliding of one wall section relative to another wall section.

10. A plant container as in claim 7, wherein the relative motion involves the rotation of one or more wall sections around hinges.

11. A plant container as in claim 7, wherein the relative motion involves the sliding of one wall section along relative to another wall section.
